(19) United States
(12) Patent Application Publication
(10) Pub. No.: US 2013/0224504 A1
(43) Pub. Date: Aug. 29, 2013

(54) METHOD FOR COATING A SUBSTRATE

(71) Applicants: Henry H. Thayer, Wethersfield, CT (US); Gary J. Larson, Madison, CT (US)

(72) Inventors: Henry H. Thayer, Wethersfield, CT (US); Gary J. Larson, Madison, CT (US)

(21) Appl. No.: 13/404,764

(22) Filed: Feb. 24, 2012

(51) Int. Cl. B32B 15/04; B05D 3/14; B05D 3/00

(52) U.S. Cl. 428/457; 427/331; 427/532

(57) ABSTRACT

A method for coating a substrate includes binding a powder material on at least one surface of a substrate using a protein-based binder and consolidating the powder material to form a coating on the substrate.

### BACKGROUND

This disclosure relates to a method for coating a substrate and, more specifically, to a method for coating a substrate using a powder material.

Coatings are known and used to protect surfaces of components, such as gas turbine engine components. There are a variety of different coating techniques that are used to deposit such coatings. One example coating technique involves depositing powder particulates onto a surface of the component and then heating the component to melt and consolidate the powder particulates. If the powder particulates do not readily adhere to the surface, the powder material can be mixed with a polymeric binder to adhere the powder.

### SUMMARY

A method for coating a substrate according to an exemplary aspect of the disclosure includes binding a powder material on at least one surface of a substrate using a protein-based binder and consolidating the powder material to form a coating on the substrate.

In a further non-limiting embodiment, the protein-based binder includes gluten.

In a further non-limiting embodiment of any of the foregoing examples, the protein-based binder includes corn gluten.

In a further non-limiting embodiment of any of the foregoing examples, the consolidating of the powder material includes applying an alternating current electric arc to the powder material.

In a further non-limiting embodiment of any of the foregoing examples, the binding of the powder material includes depositing the protein-based binder onto the at least one surface of the substrate followed by depositing of the powder material onto the protein-based binder.

In a further non-limiting embodiment of any of the foregoing examples, the depositing of the powder material onto the protein-based binder includes spraying the powder material.

In a further non-limiting embodiment of any of the foregoing examples, the substrate is a complex-shaped component and the at least one surface is hidden from a line-of-sight with respect to a reference point.

A further non-limiting embodiment of any of the foregoing examples includes depositing a solution of the protein-based binder and an inorganic solvent on the at least one surface.

In a further non-limiting embodiment of any of the foregoing examples, the solution includes 20-80 percent by volume of the protein-based binder and a remainder of the organic solvent.

In a further non-limiting embodiment of any of the foregoing examples, the solution includes 40-60 percent by volume of the protein-based binder.

A method for coating a substrate according to an exemplary aspect of the disclosure includes providing a complex-shaped component that includes a surface that is hidden from a line-of-sight with respect to a reference point, binding a powder material on the surface using a protein-based binder, and consolidating the powder material to form a coating on the surface.

In a further non-limiting embodiment of any of the foregoing examples, the protein-based binder includes gluten.

In a further non-limiting embodiment of any of the foregoing examples, the binding of the powder material includes depositing the protein-based binder onto the surface of the substrate followed by depositing the powder material onto the protein-based binder.

In a further non-limiting embodiment of any of the foregoing examples, the depositing of the powder material onto the protein-based binder includes spraying the powder material.

A further non-limiting embodiment of any of the foregoing example includes depositing a solution of the protein-based binder and an inorganic solvent on the surface.

In a further non-limiting embodiment of any of the foregoing examples, the solution includes 20-80 percent by volume of the protein-based binder and a remainder of the organic solvent.

A method for coating a substrate according to an exemplary aspect of the disclosure includes binding a powder material on at least one surface of a substrate, and consolidating the powder material using an alternating current electric arc to form a coating on the substrate.

A further non-limiting embodiment of any of the foregoing examples includes binding using a protein-based binder.

In a further non-limiting embodiment of any of the foregoing examples, the protein-based binder includes gluten.

A work piece according to an exemplary aspect of the disclosure includes a substrate, a powder material and a protein-based binder binding the powder material on at least one surface of the substrate.

In a further non-limiting embodiment of any of the foregoing examples, the protein-based binder includes gluten.

In a further non-limiting embodiment of any of the foregoing examples, the powder material is a metallic powder.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates an example method for coating a substrate.

FIG. 2 illustrates an example arrangement for coating a substrate using an alternating current electric arc.

FIG. 3 illustrates another example method for coating a substrate.

FIG. 4 illustrates an example complex-shaped component that can be coating using a method described herein.

### DETAILED DESCRIPTION OF THE PREFERRED EMBODIMENT

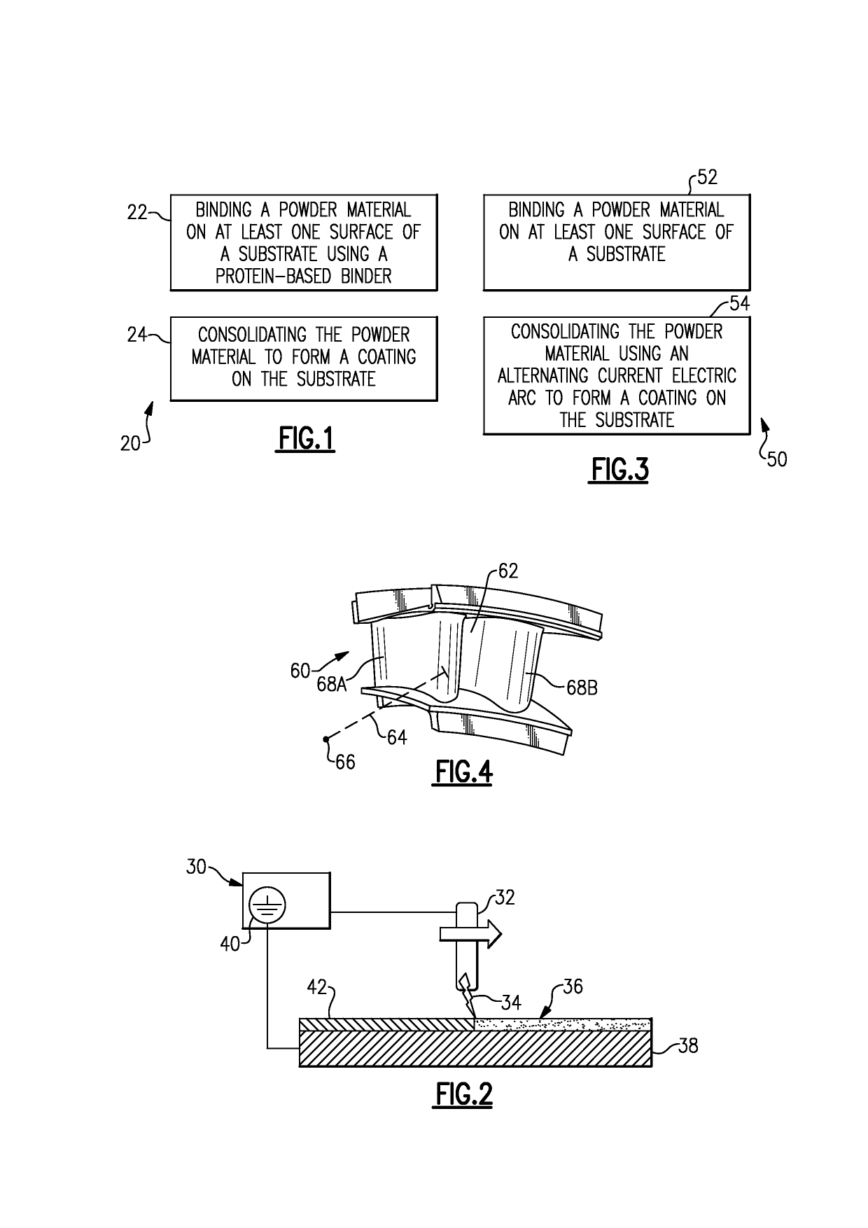

FIG. 1 shows selected actions of an example method 20 for coating a substrate work piece. As will be described, the method 20 enables a powder material to be bound to at least one surface of a substrate, such as a difficult to access surface, to form a reliable coating on the surface.

As shown, the method 20 includes a binding action 22 and a consolidating action 24. In this example, the binding action 22 includes binding a powder material on at least one surface of a substrate using a protein-based binder. The resulting work piece includes the substrate, powder material and the protein-based binder holding the powder material on the substrate. The consolidating action 24 includes consolidating the powder material to form a coating on the substrate.

In a further embodiment, the protein-based binder includes gluten, such as corn gluten, which functions to bind the powder material on the at least one surface of the substrate. The protein-based binder can be relatively cleanly removed during or prior to the consolidating action 24 without leaving a high amount of residual substance that could otherwise debit the final coating. Additionally, the protein-based binder is surprisingly effective in binding the powder material to the substrate. Thus, a relatively low amount of the protein-based binder can be used.

In one example, the protein-based binder is deposited onto the at least one surface of the substrate followed by depositing of the powder material onto the protein-based binder. That is, in this example, the protein-based binder and the powder material are separately deposited. In another example, the protein-based binder and the powder material are co-deposited onto the at least one surface of the substrate. For instance, the powder material, the protein-based binder and optionally an organic solvent are pre-mixed and then deposited onto the substrate.

In another example, the protein-based binder is provided in a solution with an organic solvent. In one example, the organic solvent is a polar solvent. In a further example, the organic solvent is ethanol. It is to be understood, however, that other polar organic solvents can alternatively be used, such as, but not limited to, water or methanol.

In a further example, the solution of the protein-based binder and the organic solvent is provided in a composition that includes 20-80 percent by volume of the protein-based binder and a remainder of the organic solvent. In a further example, the solution is provided with 40-60 percent by volume of the protein-based binder.

The solution of the protein-based binder and the organic solvent is then deposited onto the at least one surface of the substrate. For example, the solution is sprayed onto the at least one surface of the substrate, painted onto the at least one surface or deposited by dipping the substrate into the solution.

After applying the protein-based binder onto the at least one surface of the substrate, the organic solvent, if used, is then at least partially removed by evaporation. In one example, the substrate is heated to facilitate the removal of the organic solvent. In another example, the substrate is maintained at ambient conditions such that the organic solvent naturally evaporates.

If the powder material is not mixed with the protein-based binder or solution, the powder material is then deposited onto the protein-based binder on the at least one surface of the substrate. In one example, the powder material is sprayed onto the protein-based binder. In a further example, the powder material is sprayed within a stream of an inert gas, such as argon. For instance, the powder material and the argon gas are provided through a tube such that the powder material becomes entrained within the argon gas and upon discharge from an end of the tube deposits onto the protein-based binder. In that regard, the tube can be relatively small and can therefore be placed into tight areas to accurately deposit the powder material onto difficult to access surfaces of the substrate and without the need for masking. Thus, the method 20 can be used to uniformly coat surfaces that cannot be uniformly coated by deposition techniques that rely on line-of-sight.

The powder material is then consolidated at the consolidating action 24. In one example, the consolidating of the powder material includes heating the powder material to at least partially melt and fuse the powder material particulates. In further examples, the powder material is heated in a heating chamber, heated by the application of a laser, or heated by the application of an electric arc. As a further example, the powder material is consolidated to full or near full density.

In a further example, the substrate is a metallic or non-metallic substrate. In embodiments, the substrate is a superalloy material, such as a nickel- or cobalt-based superalloy.

In embodiments, the powder material is a metallic powder. As an example, the metallic powder is a superalloy, such as a nickel- or cobalt-based alloy. In a further example, the metallic powder has a composition that includes 20 percent by weight of cobalt, 15 percent by weight of chromium, 11.8 percent by weight of aluminum, 0.4 percent by weight of yttrium, 0.2 percent by weight of silicon, 0.1 percent by weight of hafnium and a remainder of nickel and any trace elements. It is to be understood, however, that other nickel-based alloys or metallic alloys will also benefit from this disclosure.

In a further example, the powder material has an average particulate size that is selected to facilitate binding with the protein-based binder. That is, relatively large, heavy particles are more difficult to bind. On the other hand, relatively small particles may be difficult to handle and deposit onto a substrate. In that regard, in one example, the particles have an average size of 0.5-88 micrometers. In a further example, the particles have an average size of 50-60 micrometers. The deposition of the powder material onto the protein-based binder can be controlled such that upon the consolidating action, the coating has a desired thickness. For example, a suitable amount of the powder material is applied such that the consolidated coating generally has a thickness of about 50-300 micrometers.

In a further embodiment, the powder material is heated by the application of an alternating current (AC) electric arc. FIG. 2 illustrates one example arrangement for consolidating a powder material using an AC electric arc. As shown, an AC electric arc device 30 includes an electrode 32 for providing an alternating current electric arc 34 between the electrode 32 and a powder material 36 that has been deposited onto a substrate 38 using the method 20. The substrate 38 is connected to a ground 40 of the electric arc device 30 to form a complete circuit for the emitted alternating current electric arc 34.

In the example shown, the electrode 32 travels across the substrate 38 such that the alternating current electric arc 34 at least partially melts and fuses the powder material 36. Alternatively, the substrate 38 can be moved relative to the electrode 32. As the alternating current electric arc 34 heats the powder material, the powder material 36 melts, fuses and solidifies to form a coating 42 on the substrate 38.

In comparison to a direct current electric arc, the alternating current electric arc 34 is effective for consolidating the powder material 36 into a relatively uniform thickness coating 42. For example, a direct current electric arc simply takes a path of least resistance through the powder material and thereby only heats a small localized region of the powder material 36. Because the direct current electric arc heats only a small localized region, the powder material and substrate in that region can over-heat, which may undesirably alter the chemistry and microstructure and locally melt the substrate. In comparison, each cycle of the alternating current electric arc 34 takes a path of least resistance through the powder material 36. Each cycle of the alternating current electric arc 34 can take a different path through the powder material 36 and thereby avoid overheating a focused localized region to more effectively consolidate the powder material 36 and reduce melting of the substrate 38. As an example, the “melted zone” of the substrate 38 is no more than 50 micrometers.

FIG. 3 illustrates selected actions of another example method 50 for coating a substrate. In this example, the method 50 includes a binding action 52 and a consolidating action 54. The binding action 52 includes binding a powder material on at least one surface of a substrate. The consolidating action 54 includes consolidating the powder material using an alternating current electric arc to form a coating on the substrate.

In a further example, either of the methods 20 or 50 can used to form a coating on a complex-shaped component 60, as shown in FIG. 4. In this example, the complex-shaped component is a gas turbine engine vane doublet, for use in a high pressure turbine, that includes a surface 62 that is hidden from a line-of-sight 64 with respect to a reference point 66. The vane doublet includes spaced apart airfoils 68A and 68B. The spacing between the airfoils 68A and 68B is relatively tight such that it is difficult to deposit uniform coatings on the surfaces in between the airfoils 68A and 68B. Thus, coating methods, such as plasma spray coating, that rely on line-of-sight have a difficulty in depositing coatings onto such surfaces.

In the illustrated example, the method 20 or 50 is used to bind a powder material on the surface 62 and then consolidate the powder material to form a coating on the surface 62. For example, the powder material is bound on the surface 62 using the protein-based binder as described above.

In another example, the powder material is consolidated using an alternating current electric arc, as described above. In a further example, the powder material is bound using the protein-based binder and then consolidated using the alternating current electric arc.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A method for coating a substrate, the method comprising:
binding a powder material on at least one surface of a substrate using a protein-based binder; and
consolidating the powder material to form a coating on the substrate.

2. The method as recited in claim 1, wherein the protein-based binder includes gluten.

3. The method as recited in claim 1, wherein the protein-based binder includes corn gluten.

4. The method as recited in claim 1, wherein the consolidating of the powder material includes applying an alternating current electric arc to the powder material.

5. The method as recited in claim 1, wherein the binding of the powder material includes depositing the protein-based binder onto the at least one surface of the substrate followed by depositing of the powder material onto the protein-based binder.

6. The method as recited in claim 5, wherein the depositing of the powder material onto the protein-based binder includes spraying the powder material.

7. The method as recited in claim 1, wherein the substrate is a complex-shaped component and the at least one surface is hidden from a line-of-sight with respect to a reference point.

8. The method as recited in claim 1, including depositing a solution of the protein-based binder and an inorganic solvent on the at least one surface.

9. The method as recited in claim 8, wherein the solution includes 20-80 percent by volume of the protein-based binder and a remainder of the organic solvent.

10. The method as recited in claim 9, wherein the solution includes 40-60 percent by volume of the protein-based binder.

11. A method for coating a substrate, the method comprising:
providing a complex-shaped component that includes a surface that is hidden from a line-of-sight with respect to a reference point;
binding a powder material on the surface using a protein-based binder; and
consolidating the powder material to form a coating on the surface.

12. The method as recited in claim 11, wherein the protein-based binder includes gluten.

13. The method as recited in claim 11, wherein the binding of the powder material includes depositing the protein-based binder onto the surface of the substrate followed by depositing the powder material onto the protein-based binder.

14. The method as recited in claim 13, wherein the depositing of the powder material onto the protein-based binder includes spraying the powder material.

15. The method as recited in claim 11, including depositing a solution of the protein-based binder and an inorganic solvent on the surface.

16. The method as recited in claim 15, wherein the solution includes 20-80 percent by volume of the protein-based binder and a remainder of the organic solvent.

17. A method for coating a substrate, the method comprising:
binding a powder material on at least one surface of a substrate; and
consolidating the powder material using an alternating current electric arc to form a coating on the substrate.

18. The method as recited in claim 17, including binding using a protein-based binder.

19. The method as recited in claim 18, wherein the protein-based binder includes gluten.

20. A work piece comprising:
a substrate;
a powder material; and
a protein-based binder binding the powder material on at least one surface of the substrate.

21. The work piece as recited in claim 20, wherein the protein-based binder includes gluten.

22. The work piece as recited in claim 20, wherein the powder material is a metallic powder.
